(19) United States
(12) Patent Application Publication
(10) Pub. No.: US 2008/0217534 A1
(43) Pub. Date: Sep. 11, 2008

(54) Scanning Electron Microscope

(75) Inventor: Eiichi SEYA, Hitachinaka (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi High-Technologies Corporation, Tokyo (JP)

(21) Appl. No.: 12/043,684

(22) Filed: Mar. 6, 2008

(30) Foreign Application Priority Data
Mar. 9, 2007 (JP) 2007-059358

(51) Int. Cl. G01N 23/00

(52) U.S. Cl. 250/310

(57) ABSTRACT

An object of the present invention is to provide a scanning electron microscope capable of facilitating the cleaning of an electrostatic chuck and also reducing unavailable time due to contamination of the electrostatic chuck. To solve the above problems, there is a proposal of an electron microscope in which a sample is loaded via an auxiliary evacuated chamber in order to carry out measurements and observations using an electron beam, the electron microscope including an electrostatic chuck replacement chamber that is different from the auxiliary evacuated chamber, and a vacuum pump for evacuating the replacement chamber. This configuration eliminates the need to restore a sample chamber to atmospheric pressure for the electrostatic chuck, and also enables effective cleaning of the electrostatic chuck.

### CLAIM OF PRIORITY

The present application claims priority from Japanese application JP 2007-59358 filed on Mar. 9, 2007, the content of which is hereby incorporated by reference into this application.

### BACKGROUND OF THE INVENTION

1. Field of the Invention

The present invention relates to a scanning electron microscope and more particularly to a scanning electron microscope having a cleaning mechanism for an electrostatic chuck.

2. Description of the Related Art

It is required that an electron microscope for use in semiconductor inspection and measurement is capable of a high throughput, and hence the electron microscope is designed to speed up a moving stage for positioning a wafer. This involves the use of an electrostatic chuck utilizing electrostatic attraction in order to firmly fix a wafer to a moving stage. The surface of such an electrostatic chuck can possibly be contaminated under the influence of a residual electric field remaining in the electrostatic chuck, or the like. Approaches for effective elimination of such contamination include an approach that involves transporting an adhesive tape along a sample traveling route to thereby attach and eliminate contaminants present partway along the route, as described for example in Japanese Patent Application Publication No. 2003-209034 (hereinafter referred to as Patent Literature 1) and Japanese Patent Application Publication No. 2006-229122 (hereinafter referred to as Patent Literature 2). Patent Literature 2 also gives a description of technology of blowing gas against the surface of the electrostatic chuck to thereby blow contaminants off the surface.

### SUMMARY OF THE INVENTION

However, the approach of transporting the adhesive tape for cleaning the electrostatic chuck, such as described in Patent Literature 1 and 2, has difficulty in completely eliminating contaminants if there is a large amount of contamination on the surface of the chuck, and such a situation requires that a sample chamber be opened to the atmosphere for cleaning.

Incidentally, a recent semiconductor tester for inspection and measurement using an electron beam or an ion beam has been such that, as a semiconductor wafer becomes larger in diameter, a vacuum chamber (i.e., the sample chamber) for holding the wafer becomes larger in size. As a result, the internal volume of the chamber becomes very large.

The temporary opening of the sample chamber to the atmosphere as mentioned above has the problem that it takes a considerable time to restore the chamber to its original operating condition.

Further, it is also required that the tester has low contamination characteristics so that no contamination is attached to the sample, since a semiconductor production process is easily affected by contaminants. Recently, it has been required that not only the surface of the wafer but also the underside thereof have low contamination, and it is considered that, for a wafer of 300 mm in diameter, it is necessary to reduce the number of contaminants of 0.2 μm or more in size to the order of a few hundreds of contaminants or less. It is also possible that the maximum permissible size of contaminant and the maximum permissible number of contaminants will become smaller as a semiconductor device will become still finer in the future.

The use of the electrostatic chuck has a tendency to increase the number of contaminants on the underside of the wafer. The reason is said to be that the underside of the wafer, when being attracted to the surface of the electrostatic chuck, makes a minute sliding movement and thus produces powder particles. A further problem is that a resist or a thin deposited film routed on the periphery of the wafer during a previous process is destroyed to form powdery contaminants when the wafer is attracted to the chuck. If this phenomenon occurs, the subsequent wafers are contaminated on the underside with a large amount of contaminants.

Accordingly, the use of the electrostatic chuck needs regular cleaning and cleaning for an increased amount of contaminants. Often used for the regular cleaning is, for example, a method that involves opening the sample chamber to the atmosphere (for example by opening an upper lid of the sample chamber), removing the electrostatic chuck, and wiping the electrostatic chuck with a nonwoven fabric by use of an organic solvent, which is generally done about once every three months.

Also, at the generation of contamination, the cleaning is generally done for example by a method that involves continuously performing the transfer and attraction of a few dummy wafers for cleaning so that contaminants on the surface of the electrostatic chuck can adhere to the undersides of the dummy wafers, and removing the dummy wafers having the contaminants adhering thereto. However, this method has difficulty in completely eliminating contaminants if there is a large amount of contaminants on the surface of the chuck. When it is the case, the need for temporarily opening the sample chamber to the atmosphere occurs for contaminant elimination using the same method as that for the regular cleaning.

However, the cleaning that involves the opening of the lid of the sample chamber has the problem of increasing the length of unavailable time of an instrument by the following reason. Such cleaning as described above requires to restore the sample chamber of large volume to atmospheric pressure and generally requires a time of the order of a few hours or longer for reproduction of a vacuum of the order of 10⁻⁴ that permits electron beam observation. This cleaning also has such a problem that a skilled maintenance operator is required to do the cleaning operation in order for the interior of the sample chamber to avoid being contaminated rather than being cleaned by the operation.

The present invention has been made in consideration for the above-described problems inherent in the related art. An object of the present invention is to facilitate the cleaning of the electrostatic chuck and also reduce the unavailable time caused by contamination of the electrostatic chuck, thereby achieving an improvement in the availability of the instrument and a reduction in maintenance costs.

According to one aspect of the present invention for solving the above problems, there is a proposal of an electron microscope including an electrostatic chuck replacement chamber that is different from the auxiliary evacuated chamber, and a vacuum pump for evacuating the replacement chamber, for the electron microscope in which a sample is loaded via an auxiliary evacuated chamber in order to carry out measurements and observations using an electron beam,. This configuration eliminates the need to restore the sample chamber to the atmospheric pressure for the electrostatic chuck, and also enables effective cleaning of the electrostatic chuck.

The above configuration enables electrostatic chuck replacement without having to open the sample chamber to the atmosphere, and thus enables reducing the unavailable time of the instrument and hence achieving high operating efficiency regardless of contamination of the electrostatic chuck.

### BRIEF DESCRIPTION OF THE DRAWINGS

FIG. 1 is a schematic plan view of an electron microscope according to one embodiment of the present invention.

FIG. 2 is a detail view of an electrostatic chuck fixing method.

FIG. 3 is a side view of the electron microscope illustrated in FIG. 1.

FIGS. 4A to 4C are views showing the procedure of electrostatic chuck replacement.

FIG. 5 is a flowchart showing a specific example of the procedure of the electrostatic chuck replacement.

### DETAILED DESCRIPTION OF THE PREFERRED EMBODIMENTS

An electron microscope for use in semiconductor inspection, including a sample chamber, a wafer loading chamber, a moving stage disposed within the sample chamber, and an electrostatic chuck for fixing a wafer on the moving stage, is provided with an electrostatic chuck fixing mechanism which the electrostatic chuck is attachable to and detachable from without the need to open an upper lid of the sample chamber, the fixing mechanism being disposed on top of the moving stage; an electrostatic chuck chamber having an opening through which the electrostatic chuck is taken out, the opening being formed in the side of the sample chamber; and a conveying mechanism that conveys the electrostatic chuck from one to another of the electrostatic chuck chamber and the sample chamber. This eliminates the need to restore the sample chamber to atmospheric pressure for cleaning of the electrostatic chuck, thus eliminating the need to stop operation of an instrument during evacuation. This configuration also eliminates erroneous contamination of the interior of the sample chamber during the cleaning of the electrostatic chuck, thus enabling even an unskilled operator to do cleaning operation.

Also, the electron microscope according to one embodiment of the present invention is further provided with a Z moving mechanism disposed within the electrostatic chuck chamber, which is movable in a Z direction while holding plural electrostatic chucks. This permits storing a spare electrostatic chuck at all times and thus enables electrostatic chuck replacement at the operator level at the generation of contamination of the electrostatic chuck. Consequently, the unavailable time of the instrument can become extremely shorter than hitherto.

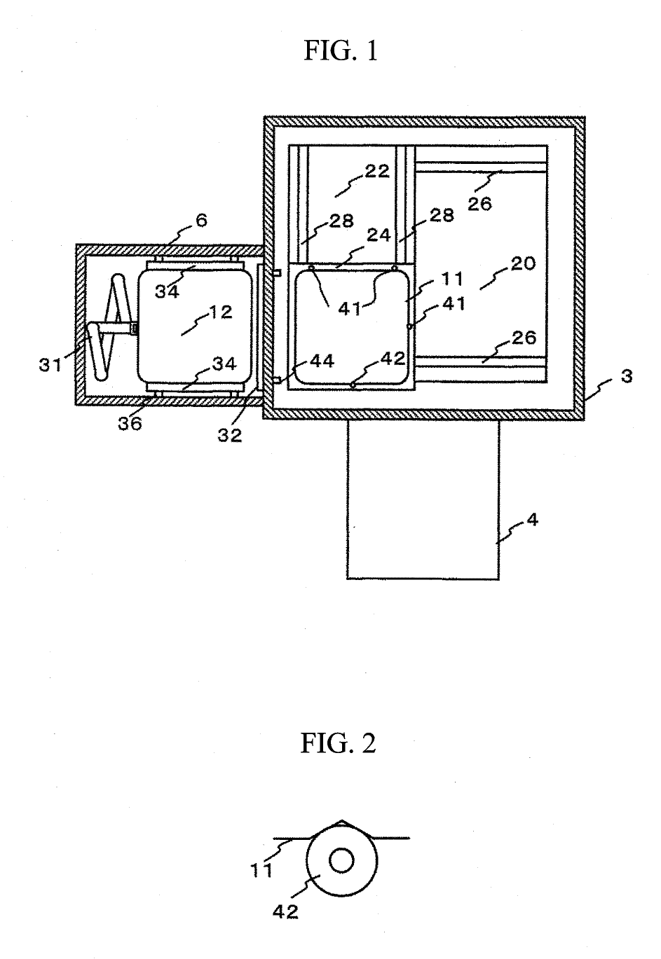

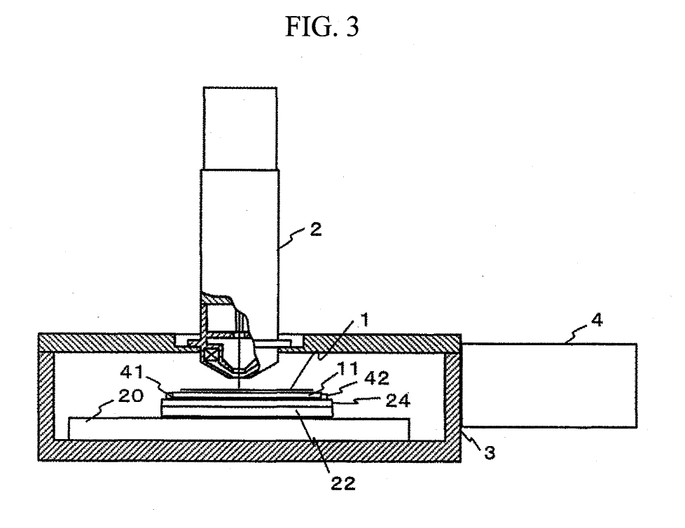

Description will be given below with regard to an embodiment of the present invention shown in the accompanying drawings. FIG. 3 is a side view of a scanning electron microscope for use in semiconductor inspection (e.g., a critical dimension-scanning electron microscope (CD-SEM)) according to one embodiment of the present invention, and FIG. 1 illustrates, in plan view, the electron microscope. This instrument has the function of irradiating the surface of the wafer with an electron beam, detecting secondary electrons or the like produced by the irradiation, and making observations and dimensional measurements on a circuit pattern or the like formed on the surface.

The instrument includes an electro-optical column 2 that focuses the electron beam into a minute beam onto a wafer 1, detects the secondary electrons emitted from the wafer and forms a microscopic image; a sample chamber 3 for maintaining a target wafer to be observed and measured under vacuum; and a wafer loading chamber (or a load lock chamber) 4 for loading and unloading the wafer into and from the sample chamber. The wafer loading chamber 4 has a connection to a vacuum pump (not shown). For the loading of the wafer into the sample chamber 3, the wafer loading chamber 4, after the loading of the wafer into the wafer loading chamber 4, is evacuated so that the degree of vacuum therein is comparable to that in a vacuum chamber, and thereafter, a valve interposed between the wafer loading chamber 4 and the sample chamber 3 is opened to thereby load the wafer into the sample chamber 3. After the loading of a new wafer into the sample chamber 3, the measured wafer is transferred out of the sample chamber 3 into the wafer loading chamber 4 with the valve held open, the wafer loading chamber 4 is opened to the atmosphere, and thereafter, the wafer is removed to the outside.

The sample chamber 3 has a wafer stage that positions the wafer 1 at any given position in an XY plane with respect to the electron beam, and the wafer stage is formed generally of a base 20, an X table 22 and a Y table 24.

An electrostatic chuck 11 for fixing the wafer 1 by electrostatic attraction is disposed on top of the Y table 24 with the electrostatic chuck fixing mechanism formed of fixed wheels 41 and a moving wheel 42.

To carry out observation and measurement on the wafer, the wafer transferred from an atmosphere-side wafer transfer system (not shown) into the wafer loading chamber 4, after the evacuation of the wafer loading chamber, is transferred onto the electrostatic chuck 11 by a wafer changing mechanism disposed within the wafer loading chamber, and the wafer is fixed by attraction on the electrostatic chuck 11. Then, after the completion of the observation and measurement, the wafer is transferred out of the sample chamber back to the wafer loading chamber 4 by the wafer changing mechanism and transferred through atmospheric leakage to the atmosphere-side wafer transfer system. Under normal operating conditions, the electrostatic chuck 11 remains fixed.

Structural components of the scanning electron microscope are appropriately controlled by a controller (not shown).

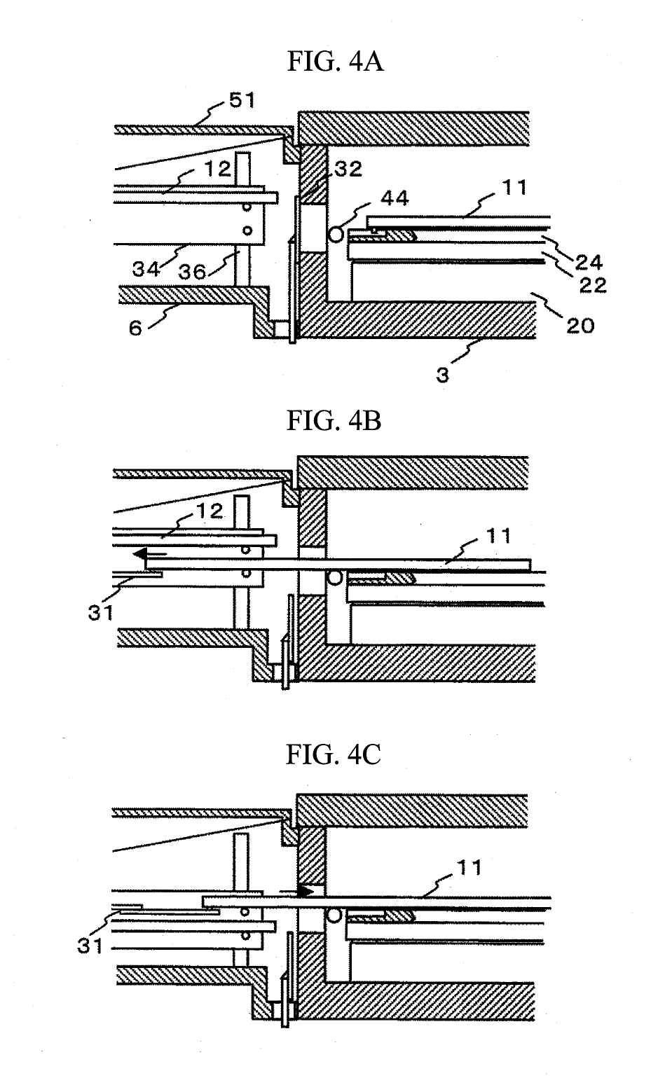

Description will now be given with reference to FIG. 1 and FIGS. 4A to 4C with regard to operation for electrostatic chuck replacement at the generation of contamination or on the occasion of regular maintenance. As shown in FIG. 1, an electrostatic chuck chamber 6 is disposed on the side of the sample chamber 3, and is provided internally with a gate valve 32 for partitioning off a vacuum in the sample chamber 3, a Z moving mechanism 34 and a Z rail 36 for effecting the movement of the electrostatic chuck in the Z direction, and a carrier arm 31. Also, as shown in FIG. 4A, the Z moving mechanism 34 is configured to hold two electrostatic chucks, and a spare electrostatic chuck 12 is shown as being held. Also, having a connection to a vacuum pump (not shown), the electrostatic chuck chamber 6 functions as an evacuated chamber in replacing the electrostatic chuck as in the case of the wafer loading chamber 4. The electrostatic chuck chamber is evacuated so that the degree of vacuum therein is comparable to that in the sample chamber 3.

The replacement of electrostatic chuck is accomplished by the following procedure.
(1) First, the wafer is unloaded, and the Y table 24 is moved to an electrostatic chuck replacement position shown in FIG. 1 (see FIG. 4A).
(2) Then, the gate valve 32 is opened, and the electrostatic chuck 11 is drawn out by the carrier arm 31 and held in a free slot in the Z moving mechanism 34 (see FIG. 4B).
(3) The Z moving mechanism 34 is moved so that the height of the spare electrostatic chuck 12 coincides with the replacement position, and the electrostatic chuck is pushed out by the carrier arm 31 and attached to the electrostatic chuck fixing mechanism on the Y table 24 (see FIG. 4C).

This procedure has no need for the leakage, the evacuation and the like during the replacement, and thus enables achieving a time of about 30 seconds for the completion of electrostatic chuck replacement operation at the operator level, which in turn is followed by the subsequent observation and measurement operations.

Also, the contaminated electrostatic chuck 11 is moved to the top of the electrostatic chuck chamber 6 by the Z moving mechanism 34 and the electrostatic chuck 11 is taken out through an opening 51 at the top of the electrostatic chuck chamber 6 after the electrostatic chuck chamber 6 is evacuated and then subjected to the cleaning operation to provide for the next replacement. This operation does not cause an increase in the length of the unavailable time of the instrument, since the operation can be performed generally concurrently with the wafer observation and measurement. Adopted for the opening 51 is a structure in which a sealing surface is formed of an inclined surface to thereby make it easy for the operator to take out the electrostatic chuck.

Incidentally, the unused spare electrostatic chuck 12 is shown as being inserted in an upper slot in the Z moving mechanism 34, and a lower slot therein is used for the contaminated electrostatic chuck 11. The reverse of this is undesirable because of having the possibility that contaminants originating from the electrostatic chuck 11 or the mechanism sections may adhere to the surface of the unused electrostatic chuck. In other words, it is desirable that the Z moving mechanism 34 be controlled so that the upper slot is always used for the unused electrostatic chuck.

Further, the instrument according to the embodiment is configured so that the wafer and the electrostatic chuck go out to the atmosphere via different routes. This enables avoiding a situation where contaminants or the like, which fall from the electrostatic chuck having the contaminants or the like adhered thereto, adheres to the wafer and then the contaminants diffuse through the travel of the wafer.

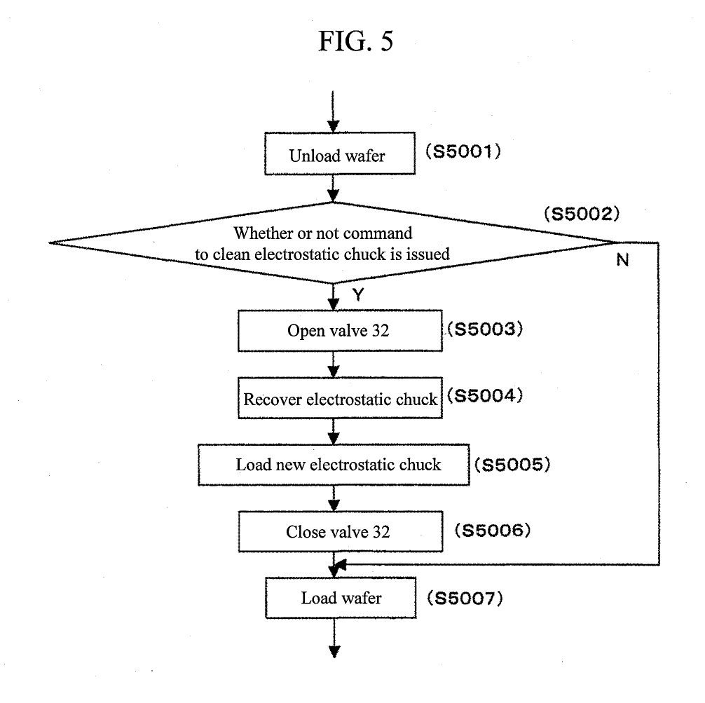

FIG. 5 is a flowchart showing a specific example of the procedure of the electrostatic chuck replacement. The wafer is unloaded from the sample chamber 3 (at step S5001), and then the controller (not shown) determines whether or not a command to clean the electrostatic chuck is issued (at step S5002). If the command to clean is issued, the electrostatic chuck chamber 6 is evacuated in advance and controlled so as to have a predetermined vacuum value. Then, the gate valve 32 is opened (at step S5003), and the electrostatic chuck is recovered from the sample chamber 3 to the electrostatic chuck chamber 6 (at step S5004). Then, the already cleaned electrostatic chuck is carried from the electrostatic chuck chamber 6 into the sample chamber 3 (at step S5005), and the gate valve 32 is closed (at step S5006). Then, the instrument is brought into normal operation, and a new target wafer to be measured is loaded into the sample chamber 3 (at step S5007).

The operation of the instrument based on the above sequence enables the electrostatic chuck replacement while minimizing the unavailable time of the instrument.

In the embodiment, three fixed wheels 41 and one moving wheel 42 disposed on the Y table 24 are used as the electrostatic chuck fixing mechanism. The fixed wheels serve to position the electrostatic chuck 11, and the moving wheel serves to press against the electrostatic chuck 11. As shown in FIG. 2, adopted is a structure in which a recess is formed in a portion of the electrostatic chuck 11 against which the moving wheel 42 fits, so that a shift in the fixed position does not occur even under an inertial force generated by the movement of the stage. Incidentally, it is to be understood that a method for fixing the electrostatic chuck is not limited to the illustrated method and that various methods such as the use of an electric actuator or gas-filled bellows are possible.

In the replacement, although a contact electrode disposed on the top surface of the Y table can be used for the supply of electric power to the electrostatic chuck, part of the fixed wheels 41, in the structure of the embodiment, may be used as an electric power supply terminal by being insulated from its surroundings.

Incidentally, although in the disclosed embodiment the operator does the cleaning of the removed electrostatic chuck, it will be readily understood by those skilled in the art that an ultrasonic cleaning device, a brush cleaning device or the like may be coupled to the electrostatic chuck removal side of the structure of the embodiment to do automatic cleaning.

Because of having the configuration as mentioned above, the electron microscope according to one embodiment of the present invention described above eliminates the need to restore the sample chamber to the atmospheric pressure for the cleaning of the electrostatic chuck, thus eliminating the need to stop the operation of the instrument during the evacuation. The electron microscope also eliminates erroneous contamination of the interior of the sample chamber during the cleaning of the electrostatic chuck, thus enabling even the unskilled operator to do the cleaning operation.

Also, the electron microscope stores the spare electrostatic chuck at all times and thus enables the electrostatic chuck replacement at the operator level at the generation of contamination of the electrostatic chuck. Consequently, the unavailable time of the instrument can become extremely shorter than hitherto.

What is claimed is:

1. A scanning electron microscope, comprising:
an electrostatic chuck that holds a sample by electrostatic attraction;
a sample chamber that maintains a sample atmosphere under vacuum;
a load lock chamber that evacuates the atmosphere in which the sample is present, at the time of loading of the sample into the sample chamber;
an evacuated chamber that is different from the load lock chamber, the sample chamber being connected to the evacuated chamber; and
a conveying mechanism that is provided to the evacuated chamber, and that conveys the electrostatic chuck from one to another of the sample chamber and the evacuated chamber.

2. The scanning electron microscope according to claim 1, further comprising a moving mechanism that is disposed within the evacuated chamber, and that moves up and down while holding a plurality of the electrostatic chucks.

3. The scanning electron microscope according to claim 1, wherein the electrostatic chuck is conveyed to the evacuated chamber via a route that is different from a traveling route of the sample.
